(19) United States
(12) Patent Application Publication
(10) Pub. No.: US 2019/0203865 A1
(43) Pub. Date: Jul. 4, 2019

(54) Low Leak Hydraulic Connector

(71) Applicant: Oceaneering International, Inc., Houston, TX (US)

(72) Inventors: William Price, Houston, TX (US); Nikunj Patel, Houston, TX (US); Julio Veliz, Cypress, TX (US)

(73) Assignee: Oceaneering International, Inc., Houston, TX (US)

(21) Appl. No.: 16/170,633

(22) Filed: Oct. 25, 2018

Related U.S. Application Data
(63) Continuation-in-part of application No. 14/859,027, filed on Sep. 18, 2015, now abandoned.

(51) Int. Cl. F16L 37/252; F16L 37/34; F16L 21/08; F16L 55/10

(52) U.S. Cl. CPC F16L 37/252; F16L 55/10; F16L 21/08; F16L 37/34

(57) ABSTRACT

A large bore hot stab connection is configured to minimize hydraulic fluid loss and to connect two fluid conduits by a substantially straight push, locking the connection into place with a relatively simple turn. In general, installation of a large bore hot stab connection is performed by inserting a hot stab into a receptacle and, if present, rotating a handle to lock the hot stab into the receptacle. As both the receptacle and hot stab comprise bodies comprising an in-line check valve cartridge valve, when inserted and coupled with the receptacle the hot stab completes a low leak hydraulic subsea connection.

### RELATION TO PRIOR APPLICATIONS

This application is a continuation-in-part of, and claims priority through, pending U.S. application Ser. No. 14/859,027 filed Aug. 18, 2015.

### BACKGROUND

Fluid conduits often need to be connected to other fluid conduits via one or more fluid connectors, e.g. connectors for making hydraulic connections to subsea equipment, overriding existing subsea systems, and hydraulically operating subsea tools. For subsea use, especially, these conduits may include large bore conduits which may require large bore hot stab connectors with low leakage to minimize environmental discharge of hydraulic fluid.

### FIGURES

Various figures are included herein which illustrate aspects of embodiments of the disclosed inventions.

FIG. 1 is a schematic view in partial perspective of an exemplary embodiment of a large bore hot stab connection system;

FIGS. 2-3 are schematic views of exemplary large bore hot stab connection receptacles;

FIG. 4 is an exploded view in partial perspective of an exemplary large bore hot stab connection receptacle;

FIGS. 5-6 are schematic views of exemplary large bore hot stab connection hot stabs;

FIG. 7 is an exploded view in partial perspective of an exemplary large bore hot stab connection hot stab; and

FIG. 8 is a side cutaway view in partial perspective of an exemplary large bore hot stab connection hot stab.

### DESCRIPTION OF EXEMPLARY EMBODIMENTS

One of ordinary skill in these arts is aware of, inter alia, ISO 13628-4, an international standard applicable in this area which defines “small-bore” as something with a known meaning, e.g. connections of up to 25.4 mm in bore. To one of ordinary skill in these arts, anything larger than a “small-bore” is a “large bore.” Thus, as used herein, a “large bore” is one which comprises a diameter around or greater than around 25.4 mm.

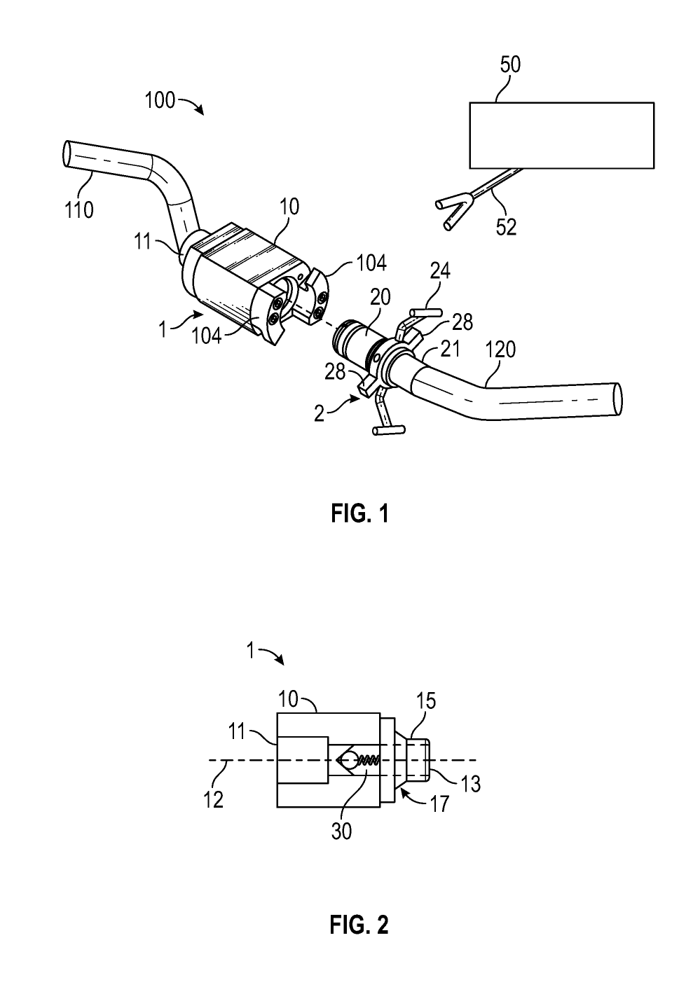

Referring to FIG. 1, large bore hot stab connection 100 comprises receptacle 1 and hot stab 2.

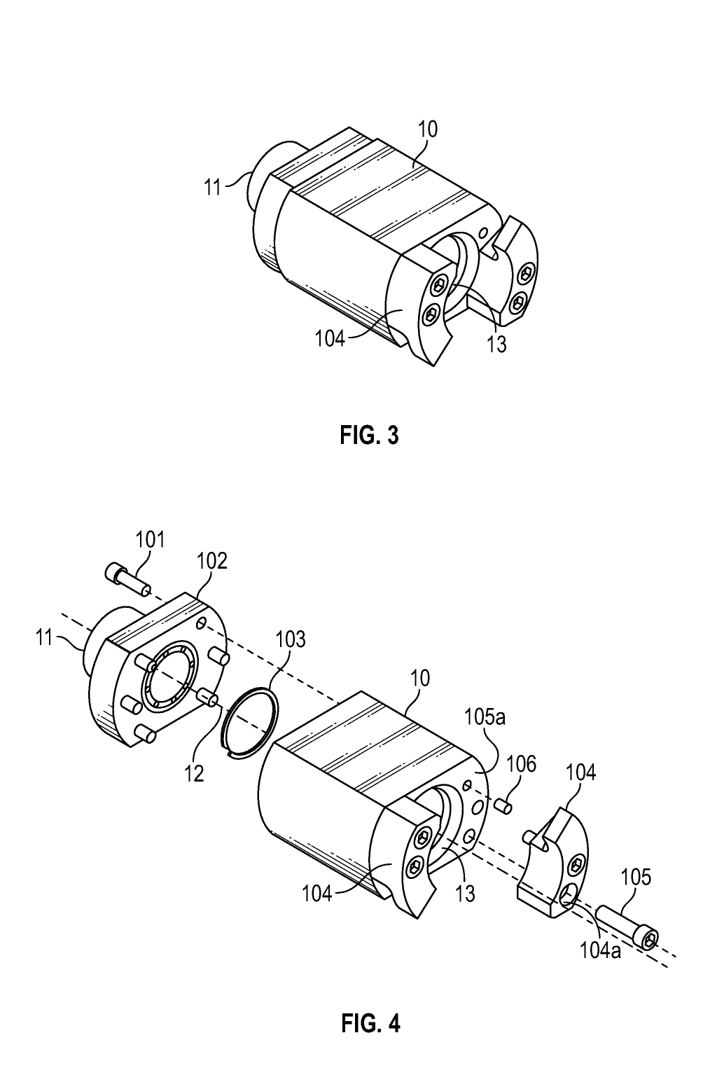

Referring additionally to FIGS. 2-3, receptacle 1 comprises body 10 and first in-line cartridge check valve 30 disposed within body 10.

First body 10 comprises first large bore fluid conduit 12 therethrough, where first body 10 further comprises first mating end 15 as well as first fluid inlet 13 and first fluid outlet 11 located at opposing ends of first large bore fluid conduit 12. First fluid inlet 13 is typically disposed proximate first mating end 15.

In currently contemplated embodiments, receptacle 1 further comprises one or more seal areas 17 disposed within or about body 10. These seal areas 17 are generally placed inside first large bore fluid conduit 12 or near first fluid inlet 13 where they can protect against mechanical damage.

First in-line cartridge check valve 30 is adapted to be removably insertable into body 10, is in fluid communication with first large bore fluid conduit 12, and is configured to allow unidirectional fluid flow within first large bore fluid conduit 12.

Referring now to FIG. 4, in certain embodiments, receptacle 1 further comprises flange 102, which may comprise a manifold, disposed proximate an end of first body 10 where first fluid outlet 11 is located. Flange 102 may be welded to first body 10 or, alternatively, fastened to first body 10 such as by using one or more fasteners 101 which are configured to be securely received into corresponding fastener bores 105a in first body 10. One or more seals 103, e.g. O-rings or the like, may be present and disposed intermediate flange 102 and first body 10.

First body 10 further comprises latch receiver 104 which, in currently contemplated embodiments, comprises two or more latch receivers 104 configured to provide a means by which hot stab 2 (FIG. 1) may be selectively, removably secured to first body 10. Each such latch receiver 104 may be a separate piece removably secured to first body 10 such as by latch fasteners 105 which are configured to be securely received into first body 10, e.g. into latch fastener bores 105a. In these embodiments, each latch receiver 104 which is secured to first body 10 comprises latch fastener bore 104a through which latch fasteners 105 are received. In addition, spring ball nose 106 may be used to help handle 24 (FIG. 1) stay latching in the lock position in latch receiver 104. Latch receiver 104 may be a J-lock.

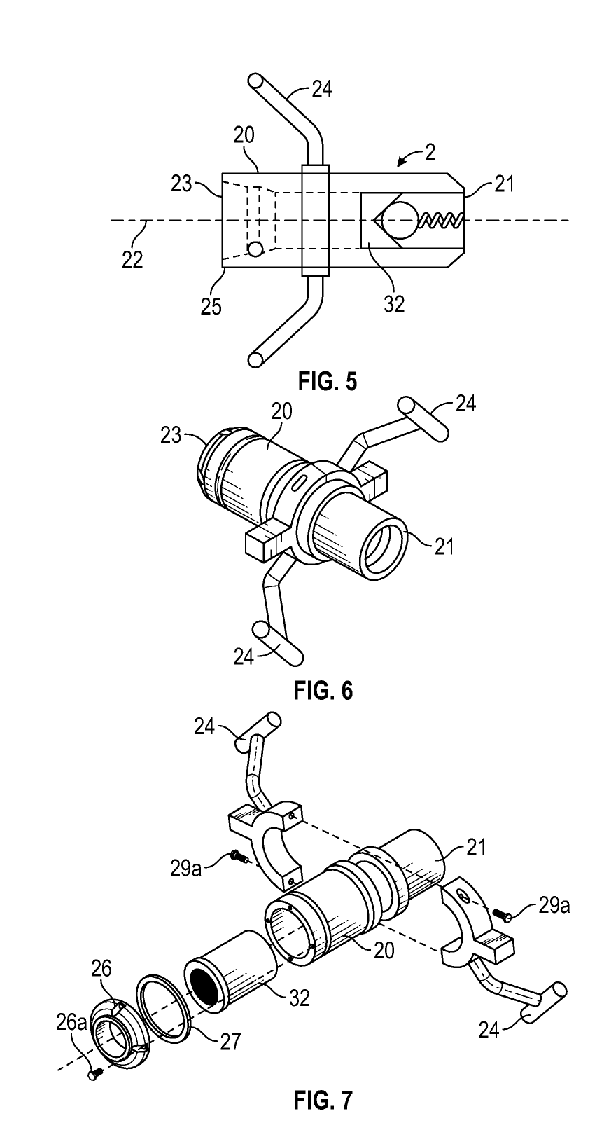

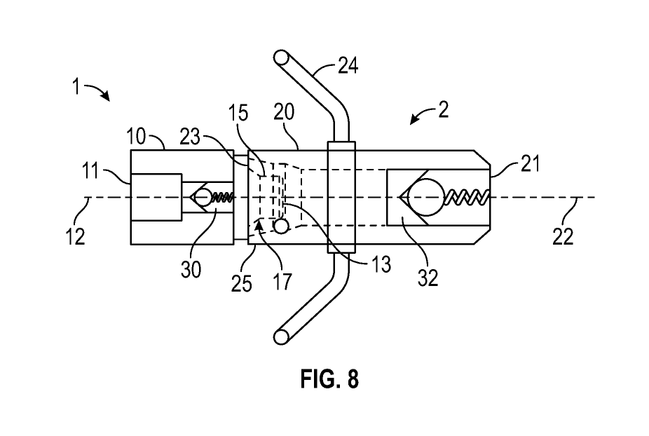

Referring now generally to FIGS. 5-6, hot stab 2 comprises second body 20; handle 24 disposed about outer surface 26 of second body 20; and second inline cartridge check valve 32 oriented in the same flow direction as first in-line cartridge check valve 30.

Second body 20 comprises mating end 23 adapted to be cooperatively receive first mating end 15; second fluid conduit 22, comprising second fluid inlet 23, disposed proximate mating end 23, and first fluid outlet 21 disposed opposite second fluid inlet 23.

Second in-line cartridge check valve 32 is typically configured to be removably insertable into second body 20, e.g. within second large bore fluid conduit 22, and allow unidirectional fluid flow within first large bore fluid conduit 22.

Handle 24 may comprise one or more latches 28, each latch 28 being configured to be selectively received into a corresponding latch receiver 104 (FIG. 1). In alternative embodiments, one or more latches 28 may be part of second body 20.

Referring additionally to FIG. 7, end cap 26 may be present to selectively secure second in-line cartridge check valve 32 within second body 20 such as by using one or more end cap fasteners 26a configured to be received through bores 26b in end cap 26 and secured into corresponding end cap fastener bores 26b in second body 20. End cap seal 27 may be disposed intermediate end cap 26 and second in-line cartridge check valve 32.

Further, in certain embodiments handle 24 is configured to snugly fit about an outer surface of second body 20. In other embodiments, handle 24 comprises two or more handles 24 which may be snugly fit about an outer surface of second body 20 and secured to each other or to second body 20 using one or more handle fasteners 29a.

The design of the connection includes a hot stab locking mechanism to prevent disengagement during operations. In certain embodiments, hot stab handle 24 is adapted to be compatible with a remotely operated vehicle (ROV), e.g. ROV 50 (FIG. 1), e.g. using ROV manipulator 52.

In the operation of exemplary embodiments, large bore hot stab connection 100 is configured and dimensioned to be usable for subsea connection of, e.g., hydraulic lines 110,120, carrying various hydraulic fluids or similar viscosity fluids and limits the amount of fluid spillage upon disconnection.

Referring generally to FIG. 1, two fluid conduits 110,120 may be connected, e.g. subsea, by installing first in-line cartridge check valve 30 into receptacle 1, where receptacle 1 is as described above and first fluid conduit 110 is connected to receptacle 1. Second in-line cartridge check valve 32 is installed into hot stab 2, where hot stab 2 is as described above. Either or both of first in-line cartridge check valve 30 and second in-line cartridge check valve 32 may be installed into their respective bodies (10,20) prior to deployment. Generally, as will be apparent to those of ordinary skill in connection arts, first in-line cartridge check valve 30 and second in-line cartridge check valve 32 are typically urged into a closed position such as by a spring until sufficient fluid pressure exists to urge the valves into their open position, thereby allowing fluid flow. In other embodiments, first in-line cartridge check valve 30 and second in-line cartridge check valve 32 may be dual acting check valves that can open/check in both directions.

Second fluid conduit 120 is connected to hot stab 2 and hot stab 2 inserted into receptacle 1. Handle 24 may then be rotated in a first predetermined direction to lock hot stab 2 into receptacle 1 such as by securing one or more latches 28 into corresponding latch receivers 104. After hot stab 2 is locked into receptacle 1, fluid pressure in the upstream fluid conduit can be allowed to achieve a pressure level sufficient to open both first in-line cartridge check valve 30 and second in-line cartridge check valve 32.

The two cartridge check valves, 30 and 32, may be replaced as needed, e.g. if damaged, malfunctioning, or different cracking pressures are required. When and if needed, hot stab 2 may be rotated in a direction until hot stab 2 is disengaged from receptacle 1 and hot stab 2 then removed from receptacle 1. Before or after hot stab 2 is removed from receptacle 1, fluid pressure in the conduits can be to fall below the level sufficient to open both first in-line cartridge check valve 30 and second in-line cartridge check valve 32, allowing one or both of first in-line cartridge check valve 30 and second in-line cartridge check valve 32 to close. Additionally, the direction of first in-line cartridge check valve 30 and second in-line cartridge check valve 32 may be switched to allow fluid flow in an opposite direction. In most cases, however, first in-line cartridge check valve 30 and second in-line cartridge check valve 32 will both need to be switched and pointing in the same direction. i.e. you can from from the receptacle to the hot stab or vice-a-versa.

Once hot stab 2 is removed from receptacle 1, either or both of first in-line cartridge check valve 30 and second in-line cartridge check valve 32 may be replaced in their respective bodies (10,20). Once the desired check valves 30,32 are replaced, hot stab 2 is reinserted into receptacle 1, after which hot stab 2 may be rotated until hot stab 2 is secured into receptacle 1 such as by securing one or more latches 28 into corresponding latch receivers 104. After hot stab 2 is locked into receptacle 1, fluid pressure in the upstream fluid conduit can again be allowed to achieve a pressure level sufficient to open both first in-line cartridge check valve 30 and second in-line cartridge check valve 32.

Where handle 24 is adapted to be manipulated by ROV 50, ROV 50 may be used to position hot stab 2 proximate receptacle 1, insert hot stab 2 into receptacle 1, and rotate hot stab 2 until hot stab 2 is secured into receptacle 1 such as by securing one or more latches 28 into corresponding latch receivers 104.

The foregoing disclosure and description of the inventions are illustrative and explanatory. Various changes in the size, shape, and materials, as well as in the details of the illustrative construction and/or an illustrative method may be made without departing from the spirit of the invention.

We claim:

1. A large bore hot stab connection, comprising:
a. a receptacle comprising:
i. a first body comprising:
1. a first mating end;
2. a first fluid inlet disposed proximate the first mating end;
3. a first fluid outlet disposed opposite the first fluid inlet; and
4. a first large bore fluid conduit therethrough, the first large bore fluid conduit in fluid communication with the first fluid inlet and the first fluid outlet, the large bore fluid conduit comprising a diameter of at least around 25.4 mm;
ii. a seal area disposed within the first large bore fluid conduit;
iii. a first in-line cartridge check valve disposed within the first body and in fluid communication with the fluid conduit, the first in-line cartridge check valve defining an allowed fluid flow direction; and
iv. a latch receiver disposed proximate the first mating end; and
b. a hot stab comprising:
i. a second body, comprising:
1. a second mating end adapted to cooperatively receive the first mating end;
2. a second fluid inlet disposed proximate the second mating end;
3. a second fluid outlet disposed opposite the second fluid inlet; and
4. a second large bore fluid conduit therethrough, the second large bore fluid conduit in fluid communication with the second fluid inlet and the second fluid outlet;
ii. a handle snugly disposed about an outer surface of the second body;
iii. a second inline cartridge check valve oriented in the same flow direction as the first in-line cartridge check valve along the allowed fluid flow direction; and
iv. a latch disposed proximate second mating end and dimensioned to be received into the latch receiver.

2. The large bore hot stab connection of claim 1, wherein the first in-line cartridge check valve comprises a removably disposed in-line cartridge check valve disposed within the first body

3. The large bore hot stab connection of claim 1, wherein the second in-line cartridge check valve comprises a removably in-line cartridge check valve disposed within the second body.

4. The large bore hot stab connection of claim 1, wherein the receptacle further comprises a flange fastened to the body proximate the first fluid outlet.

5. The large bore hot stab connection of claim 4, wherein the flange comprises a removable flange fastened to the body proximate the first fluid outlet using a fastener.

6. The large bore hot stab connection of claim 4, wherein the flange is welded to the body proximate the first fluid outlet.

7. The large bore hot stab connection of claim 4, further comprising a seal disposed intermediate the flange and the first body.

8. The large bore hot stab connection of claim 1, wherein:
a. the latch receiver comprises a removable latch receiver disposed proximate the first mating end;
b. the first body further comprises a latch fastener receiver; and
c. the latch receiver further comprises:
i. a latch fastener bore; and
ii. a latch fastener dimensioned to be securely received into the latch fastener bore.

9. The large bore hot stab connection of claim 8, further comprising a latch receiver sleeve dimensioned to be received into the latch receiver bore.

10. The large bore hot stab connection of claim 1, further comprising an end cap disposed about an end of the second body proximate the second inline cartridge check valve and dimensioned to selectively, removably secure the second inline cartridge check valve within second body.

11. The large bore hot stab connection of claim 10, wherein the second body comprises an end cap fastener receiver, the large bore hot stab connection further comprising an end cap fastener dimensioned to be secured into the end cap fastener receiver and selectively, removably secure the end cap to the second body.

12. The large bore hot stab connection of claim 1, wherein the handle comprises a remotely operated vehicle compatible handle.

13. The large bore hot stab connection of claim 1, wherein the handle comprises a plurality of handlers, at least two of which secured to each other using a handle fastener.

14. The large bore hot stab connection of claim 1, wherein at least one of the first in-line cartridge check valve and the second in-line cartridge check valve comprises a dual acting check valve.

15. A method of connecting two fluid conduits subsea, comprising:
a. installing a first in-line cartridge check valve into a receptacle, the receptacle comprising:
i. a body comprising:
1. a large bore comprising a diameter of at least around 25.4 mm; and
2. an open end; and
ii. a seal area within the large bore;
b. connecting a first fluid conduit to the receptacle;
c. installing a second in-line cartridge check valve into a hot stab, the hot stab comprising:
i. a mating end adapted to be cooperatively received into the receptacle open end;
ii. a handle disposed about an outer surface of the hot stab; and
iii. a inline cartridge check valve oriented in the same flow direction as the receptacle in-line cartridge check valve;
d. connecting a second fluid conduit to the hot stab;
e. inserting the hot stab into the receptacle; and
f. rotating the handle of the hot stab in a first predetermined direction to lock the hot stab into the receptacle.

16. The method of claim 15, further comprising:
a. rotating the hot stab until the hot stab is disengaged from the receptacle;
b. removing the hot stab from the receptacle;
c. replacing at least one of the first in-line cartridge check valve or the second in-line cartridge check valve;
d. reinserting the hot stab into the receptacle; and
e. rotating the hot stab until the hot stab is secured into the receptacle

17. The method of claim 15, wherein the handle comprises a remotely operated vehicle (ROV) manipulatable handle, the method further comprising:
a. using an ROV to position the hot stab proximate the receptacle;
b. using the ROV to insert the hot stab into the receptacle; and
c. using the ROV to rotate the hot stab until the hot stab is secured into the receptacle via the ROV manipulatable handle.

18. The method of claim 15, wherein the first in-line cartridge check valve and the second in-line cartridge check valve are installed prior to deployment of the receptacle and hot stab sub sea.
